(19) United States
(12) Patent Application Publication
(10) Pub. No.: US 2024/0118829 A1
(43) Pub. Date: Apr. 11, 2024

(54) RELOCATION OF DATA IN A STORAGE DEVICE BASED ON ACCESS INFORMATION

(71) Applicant: Dell Products L.P., Round Rock, TX (US)

(72) Inventors: Shane Oh, Singapore (SG); Chai Im Teoh, Singapore (SG); Young Hwan Jang, Singapore (SG)

(73) Assignee: Dell Products L.P., Round Rock, TX (US)

(21) Appl. No.: 17/938,237

(22) Filed: Oct. 5, 2022

(51) Int. Cl. G06F 3/06

(52) U.S. Cl. CPC G06F 3/0659; G06F 3/0604; G06F 3/064; G06F 3/0679

(57) ABSTRACT

Aspects of this disclosure improve data availability by decreasing access times to obtain data from the storage device while still providing high memory density. A method may include identifying, by a controller of a non-volatile solid-state storage device, first data that matches a criteria based on access information regarding data stored in a solid state drive as targeted data; writing, by the controller of the non-volatile solid-state storage device, the targeted data from a first portion of the non-volatile solid-state storage device configured as a first type to a second portion of the non-volatile solid-state storage device configured as a second type; and tagging, by the controller of the non-volatile solid-state storage device, the data with a tag based on the access information. Other aspects are also disclosed.

### FIELD OF THE DISCLOSURE

The instant disclosure relates to information handling systems. More specifically, portions of this disclosure relate to storage systems for information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

The amount of information that information handling systems process and/or store continues to increase. For example, data for applications executed on high resolution displays includes higher resolution graphics content. As another example, data for applications executed on surround sound audio systems includes higher resolution audio content and additional audio channels corresponding to, for example, 5.1, 7.1, 9.1, 11.1, or higher channels of surround sound content. In these examples, the audio and graphics content consume more storage, which places a demand on information handling systems to provide more storage. Additionally, increases in information handling system processing speed demands faster access to the larger files in order to remain responsive to user input and user requests. The demands for increased storage and increased access speeds to storage are both further challenged by demands to further reduce size of the information handling system.

Aspects of this disclosure implement a hybrid storage device, which provides both higher-density storage of data and quicker access times to the data. Hybrid storage devices may include a single physical structure for memory cells, in which a first portion of the memory cells are configured for one priority and a second portion of the memory cells are configured for another priority. For example, a hybrid storage device may have a first portion of storage configured with a memory cell type that provides higher-density storage and slower access to data and a second portion of storage configured with a memory cell type that provides quicker access to data (than the first portion) and lower-density storage (than the first portion). In some embodiments of a hybrid storage device, the first portion may be a quad-level cell (QLC) capable of storing two bits of information (e.g., four bits per cell corresponding to 1111, 1110, 1101, 1100, 1011, 1010, 1001, 1000, 0111, 0110, 0101, 0100, 0011, 0010, 0001, 0000) and the second portion may be a single-level cell (SLC) capable of storing one bit of information (e.g., two levels corresponding to 0, 1).

Although QLC and SLC memory cell types are used in some example embodiments, other embodiments may user other configurations of higher-level cells (HLCs) and reduced level cells (RLCs), in which RLCs store fewer bits than HLCs. RLC memory cells may have quicker access times because they have fewer levels and thus larger noise margins during read-out of the cells. HLC cells may have higher storage density because they allow two, three, or more bits to be stored in a single memory cell. As used herein, access speed may refer to a time to begin transfer of the requested data from the memory cells, a data rate at which the requested data is transferred from the memory cells, or a total time to complete data transfer of the requested data from receipt of the request command at the storage device to output of the last bit of the requested data to a bus coupling the storage device to another component.

In some aspects of this disclosure, data may be transferred between two or more portions of a hybrid storage device to prioritize an aspect of accessing the data corresponding to the characteristics of the portion of the device storing the data. For example, the data may be stored in a first portion of the device when increasing storage density of the data is prioritized and the data may be stored in a second portion of the device when increasing access speed to the data is prioritized. When certain data is prioritized for lower access time the data, if present in the first portion, may be copied or moved to the second portion. Information regarding the use of the information handling system may indicate an upcoming request or a likelihood of an upcoming request for particular data in the hybrid storage device. That particular data may be copied or moved pre-emptively or on-demand from the first portion of storage to the second portion of storage. Although two portions of a memory device are described in embodiments herein, the hybrid storage device may include three or more portions of memory, each having different characteristics, and data may be copied or moved into those portions to obtain a desired characteristic for access to the data.

According to one embodiment, a method may include identifying, by a controller of a non-volatile solid-state storage device, first data that matches a criteria based on access information regarding data stored in a solid state drive as targeted data; and writing, by the controller of the non-volatile solid-state storage device, the targeted data from a first portion of the non-volatile solid-state storage device configured as a first type to a second portion of the non-volatile solid-state storage device configured as a second type.

In certain embodiments, the first portion of the non-volatile solid-state storage device configured as the first type is configured with increased memory density above a memory density of the second portion and/or the second portion of the non-volatile solid-state storage device configured as the second type is configured with decreased access times lower than access times of the first portion.

In certain embodiments, the first portion comprises memory cells configured as multi-level cells (MLCs), three-level cells (TLCs), quad-level cells (QLCs), or higher level cells (collectively referred to as higher-level cells (HLCs)) and the second portion comprises memory cells configured as single-level cells (SLCs) or another type of cell with less levels that the first type (referred to as a reduced level cell (RLC)). For example, when the first type is a multi-level cell MLC with two levels, the RLC is a single-level cell (SLC). As another example, when the first type is a quad-level cell QLC with four levels, the second type may be a RLC of either single-level cells (SLCs), multi-level cells (MLCs), or triple-level cells (TLCs).

In certain embodiments, the method may include configuring, by the controller of the non-volatile solid-state storage device, a first subset of one or more banks of the non-volatile solid-state storage device as single-level cells (SLCs) and a second subset of the one or more banks as multi-level cells (MLCs).

In certain embodiments, identifying the targeted data comprises reading the read reclaim algorithm track read counts for a plurality of NAND blocks in the solid-state drive. The identifying of the target data may comprise determining if the read count is greater than a read reclaim trigger setting value.

In certain embodiments, the method may include tagging, by the controller of the non-volatile solid-state storage device, the data with a tag based on the access information.

In certain embodiments, the method may include determining to evict data from the second portion of the non-volatile solid-state storage device; identifying second data not associated with the tag; and evicting the second data associated with the tag.

According to another embodiment, an apparatus may include one or more banks of non-volatile solid-state storage, the one or more banks comprising a first portion configured as a first type and a second portion configured as a second type; and a storage controller coupled to the one or more banks and configured to manage data stored in the one or more banks, wherein the storage controller comprises a processor or other logic circuitry configured to perform the steps described in methods described herein.

According to a further embodiment, an information handling system may include a storage device, a memory, and a processor coupled to the memory and to the storage device. The storage device may include a plurality of banks of non-volatile memory comprising a first portion configured as a first type and a second portion configured as a second type; and a storage controller coupled to the plurality of banks and configured to read data and write data to the plurality of banks. The processor may be configured to perform steps described in methods described herein including, for example, identifying, by a controller of a non-volatile solid-state storage device, first data that matches a criteria based on access information regarding data stored in a solid state drive as targeted data; and writing, by the controller of the non-volatile solid-state storage device, the targeted data from a first portion of the non-volatile solid-state storage device configured as a first type to a second portion of the non-volatile solid-state storage device configured as a second type.

The method may be embedded in a computer-readable medium as computer program code comprising instructions that cause a processor to perform operations corresponding to the steps of the method. In some embodiments, the processor may be part of an information handling system including a first network adaptor configured to transmit data over a first network connection; and a processor coupled to the first network adaptor, and the memory.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1A is a block diagram illustrating a storage device with data stored between two types of available memory cells according to some embodiments of the disclosure.

FIG. 1B is a block diagram illustrating a storage device with data stored with prioritized access to certain data available based on storage in one type of available memory cells according to some embodiments of the disclosure.

FIG. 1C is a block diagram illustrating a storage device with data with reduced prioritized access to certain data available based on storage in one type of available memory cells according to some embodiments of the disclosure.

FIG. 2 is a flow chart illustrating a method of operating a storage device according to some embodiments of the disclosure.

FIG. 3 is a block diagram illustrating a system architecture for operating a hybrid storage device according to some embodiments of the disclosure.

FIG. 4 is a flow chart illustrating a method of operating a storage device according to some embodiments of the disclosure.

FIG. 5 is a flow chart illustrating a method of data allocation based on prioritized access within the hybrid storage device according to some embodiments of the disclosure.

FIG. 6 is a schematic block diagram of an example information handling system according to some embodiments of the disclosure.

### DETAILED DESCRIPTION

Aspects of the disclosure include apparatuses, configurations, and/or data access methods for improving solid-state drive reliability for hot read data and reducing data movement occurrence for read disturb handling. In one embodiment, the data addresses which require read reclaim can be identified by the solid-state drive as hot data. In another embodiment, the SSD controller may tag the hot data with a tag based on access information.

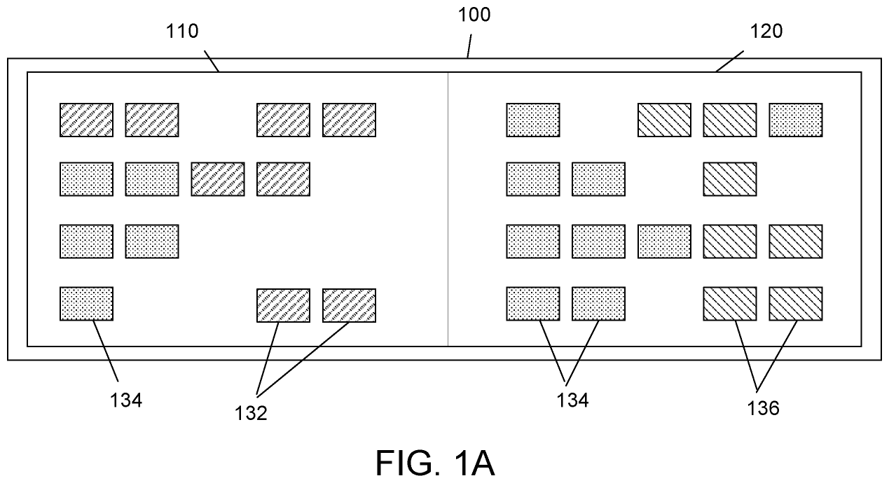

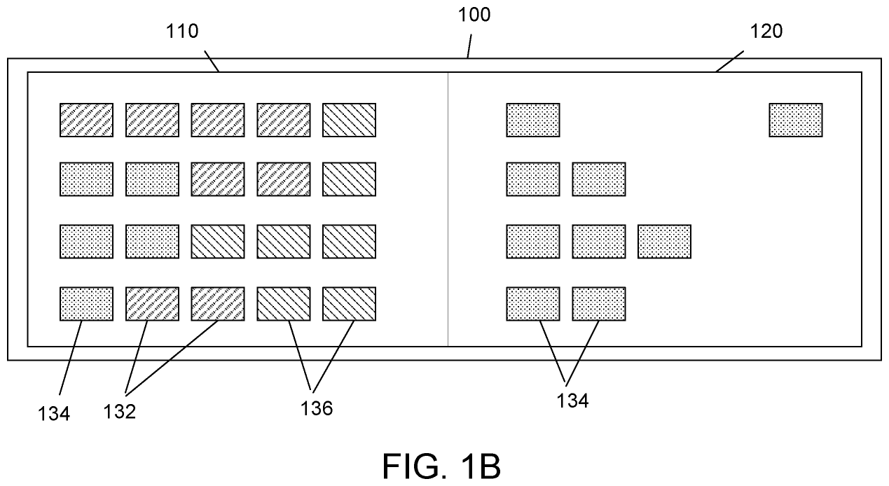

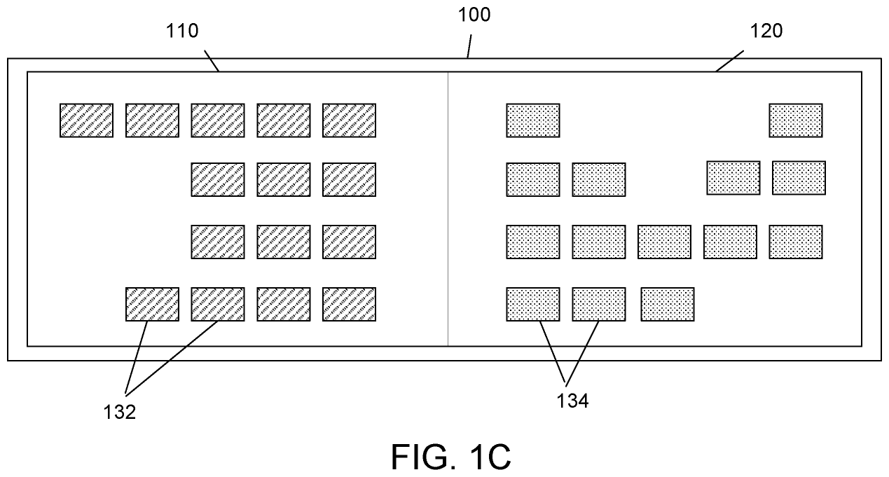

FIG. 1A and FIG. 1B illustrate a hybrid storage device before and after reorganization of data within the device. FIG. 1A is a block diagram illustrating a storage device with data initially stored between two types of available memory cells according to some embodiments of the disclosure. Data may be migrated between the two types of available memory cells in the memory device based on, for example, predicted access to certain portions of data, such that access to the data is faster. FIG. 1B is a block diagram illustrating a storage device with data stored afterrelocating certain data to prioritize access according to some embodiments of the disclosure.

Referring to FIG. 1A, the non-volatile solid-state data storage device 100 includes a second type 110 and a first type 120 of cells storage. The first type 110 of storage cells may include cells that are configured as quad-level cells (QLCs) having a higher storage density than when the cells are configured as single-level cells (SLCs). Although combinations of QLCs and SLCs are described for device 100, the device 100 may include other combinations of HLCs and RLCs. Reduced-level cell refers to a cell configured with a lower number of storage levels than an HLC. For example, a reduced level from quad-level may be bi-level (also referred to a multi-level MLC), and another example of a reduced level from quad-level may be single level. A second type 120 of storage cells may include cells that are configured as quad-level cells (QLCs) or other higher-level cells (HLCs) or as single-level cells or other reduced-level cells (RLCs). Each type 110, 120 of storage may store a mixture of first data 132, second data 134, and third data 136. Data may be reorganized within the different types 110, 120 of cells in storage device 100. The first data 132 may be, for example, tagged data stored in the second type 110. The second data 134 may be, for example, cold read data or data that is not frequently accessed. The third data 136 may be, for example, hot read data or data that is frequently accessed. Examples of hot read data may include application data for applications that are frequently executed by a user of an information handling system. Although application use may vary by user, commonly-accessed application data may include certain portions of an operation system, web browser applications, and/or document processing applications.

Whether data is frequently or infrequently accessed (e.g., cold read data or hot read data) may be determined by the device 100 or by a host device managing the device 100. For example, the device 100 may execute a read reclaim algorithm. In another example, the device 100 may store read counts corresponding to individual cells or blocks of cells, and the counts may be compared to threshold values to distinguish cold read data from hot read data. In a further example, a predictive algorithm may be used to predict whether certain data 132, 134, and 136 will be frequently or infrequently accessed.

Data may be reorganized based on information about predicted and/or historical frequency of access to the data 132, 134, 136. For example, certain data may be preferably stored in the first type 110 of cells and certain other data in the second type 120 of cells. In some embodiments, memory cells of the first type 110 are part of a first set of banks within the storage device and memory cells of the second type 120 are part of a second set of banks within the storage device. A memory bank may be a set of memory cells that share components including one or more of read-out circuitry, address decoding, data latches, and/or control logic. For example, a memory bank may be a set of memory cells that share a column decoder (CD), secondary sense amplifiers (SSA), and/or row decoders (RD). Each of the first and/or second types 110, 120 may include one or multiple memory banks of the corresponding type.

An example of movement of data between the types 110, 120 is shown in FIG. 1B. Referring to FIG. 1B, the third data 136 moved to the second type 110 of storage from the first type 120 of storage. The presence of third data 136 in second type 110 of storage allows quicker access to the third data 136 by an information handling system. For example, when third data 136 is code for an application known to be executed around a certain time of day, the third data 136 may be preloaded into the second type 110 of storage around the certain time of day. Other techniques for arranging data between the first type 120 and second type 110 of storage may include analysis of historical access trends to the data 136, prediction of access to the data 136, analysis of characteristics of the data 136, or a combination thereof.

Referring to FIG. 1C, the second data 134 moved to the first type 120 of storage from the second type 110 of storage. The presence of first data 132 in second type 110 of storage allows quicker access to the first data 132 by an information handling system. The second type 110 of storage may comprise memory cells configured as reduced-level cells (RLCs), or, for example, single-level cells (SLCs). When the SLC buffer is determined to be full or meets other predefined criteria, second data 134 which has been determined as cold data, data with lower priority, lower read count, or otherwise identified as cold databased on access information, is transferred to the first type 120 of storage, which may comprise memory cells configured as HLCs with a higher number of levels than the first type 110 of storage. Other techniques for arranging data between the first type 120 and second type 110 of storage may include analysis of historical access trends to the data 136, prediction of access to the data 136, analysis of characteristics of the data 136, or a combination thereof.

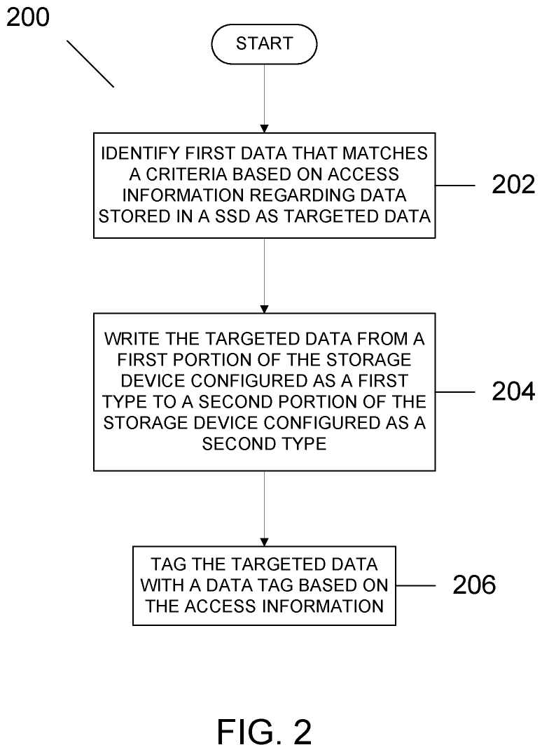

FIG. 2 is a flow chart illustrating a method of operating a storage device according to some embodiments of the disclosure. Method 200 may be performed, for example, by a CPU or embedded controller (EC) of a host device or a SSD storage device. At block 202, the SSD controller identifies first data that matches criteria based on access information regarding data stored in a first portion of the non-volatile solid-state storage device. Access information may include, for example, a program/erase cycle, an erase count, a program count, a read count, a wear-level count, an elapsed time, and/or an operation temperature. Upon identifying the first data based on the access information, the first data is tagged as targeted data for relocation. The storage command may suggest certain information access to the storage device, such as in a Data Set Management (DSM) hint or workload hint, and that hint used to determine the targeted data.

At block 204, the SSD controller writes the identified data to the second type 110 of storage. In some embodiments, the write of block 204 may be a move operation, in which the data associated with the indicator is also deleted from an original location in, for example, the first type 120 of storage. In some embodiments, the write of block 204 may be a copy operation, in which the data associated with the indicator remains in the original location. The writing of the targeted data from the first type of storage to the second type of storage reduces data movement occurrence for read disturb handling and increases read performance.

At block 206, the targeted data written to the second type of storage is tagged by the controller with a tag based on the access information. The tag may include an identifier to allow identifying within the storage device for example, the first data 132, the second data 134, and the third data 136. The tags may be label data to allow moving of specific data between the first portion and the second portion. The tags may be communicated to the storage device as, for example, an NVMe Directive ID and/or D_type. The tags may be saved to a mapping file for the first type of storage's data addresses.

Method 200 may be executed, for example, by an operating system (O/S) service to position data within the storage device. In some embodiments, the repositioning of data in the device may be based on a predicted usage, such as by identifying a likelihood of certain data for access at certain times. The O/S service may use temporal, geospatial, and/or access patterns and/or other information. The O/S service may then transmit a storage command to the storage device comprising an indicator corresponding to the predicted data to write the predicted data from a first portion of storage to a second portion of storage.

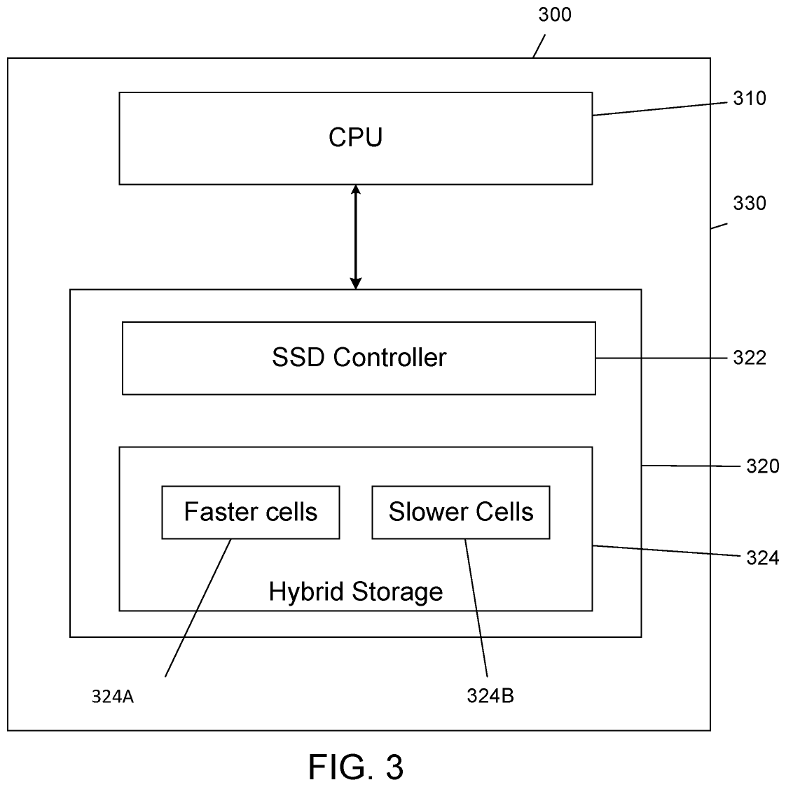

FIG. 3 is a block diagram illustrating a system architecture for operating a hybrid storage device according to some embodiments of the disclosure. The CPU 310 uses NVMe or other transport over bus 330 to send signals (e.g., commands and/or data) to the SSD Controller 322 within the storage device 320. SSD Controller 322 communicates with the hybrid storage 324, e.g., over an internal bus. The hybrid storage 324 may include a first portion configured as a first type of storage 324B and a second portion configured as a second type of storage 324A.

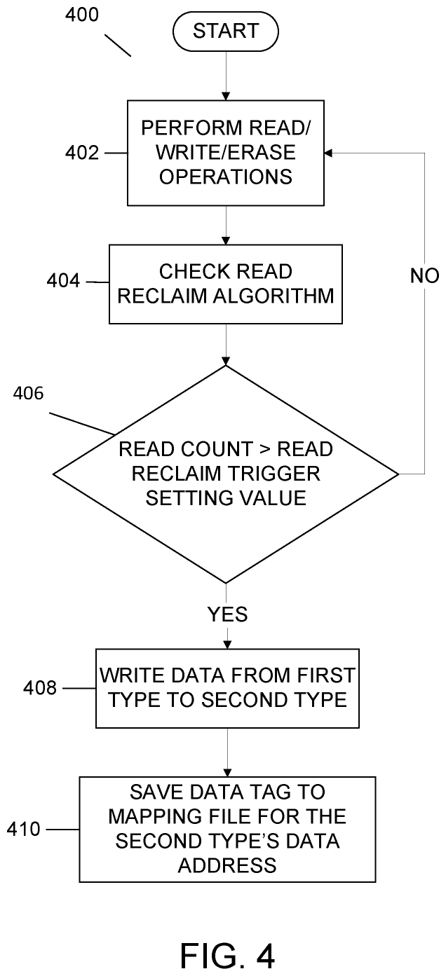

FIG. 4 is a flow chart illustrating a method of operating a storage device according to some embodiments of the disclosure. Flowchart 400 illustrates a method of operating a storage device according to some embodiments of the disclosure. Upon boot up of the information handling system, the SSD controller may routinely perform various read, write, and erase operations 402. In order to boost read performance, the SSD may implement read reclaim and may also adjust the read reclaim trigger setting value using a multiple read count value to determine which data should be considered hot data. The SSD controller proceeds to check the read reclaim algorithm at block 404 to read track read counts for a plurality of NAND blocks in the SSD. At decision block 406, the SSD controller determines if the read count is greater than a read reclaim trigger setting value. If so, the data is determined to be targeted/hot/frequently-accessed data, and is written from the first type of storage to the second type of storage at block 408. If not, the controller proceeds to continue routine operations at block 402. After writing the targeted data to the second type of storage, the controller may save the data tag to a mapping file for the second type of storage's data address at block 410. The mapping file may associate the targeted data from the first type of storage to the second type of storage and provide access to the targeted data without having to map the entirety of the targeted data, but only the data tag being saved by the controller. The mapping file may also include the association of the targeted data's contents with the second type of storage's data address.

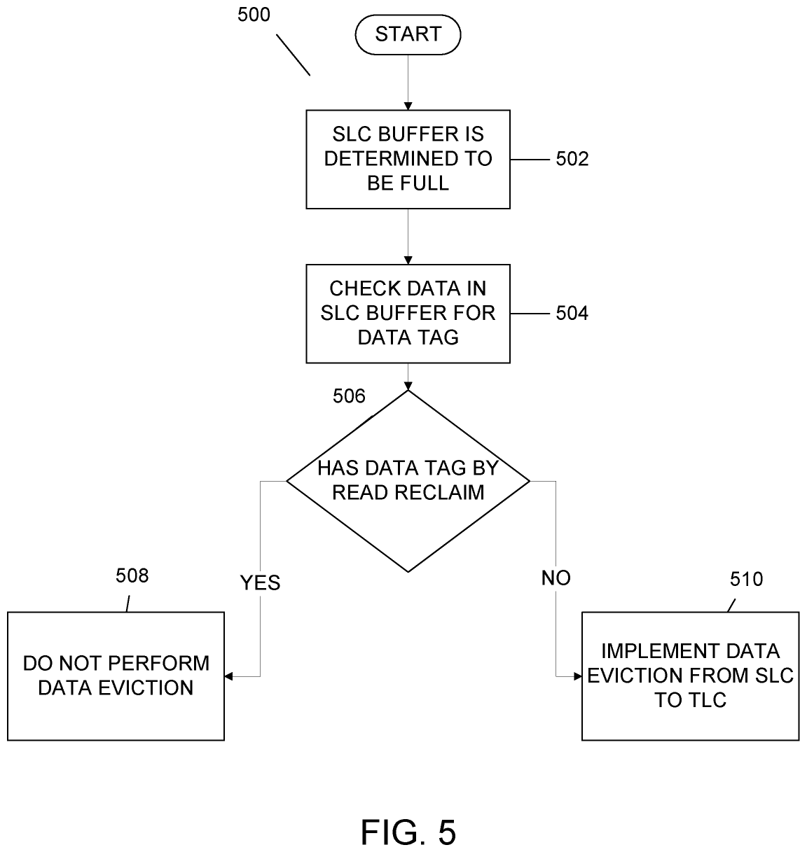

FIG. 5 is a flow chart illustrating a method of data allocation based on prioritized access within the hybrid storage device according to some embodiments of the disclosure. Flowchart 500 illustrates the data allocation in the event that the second type of storage is determined to be full. More specifically, flowchart 500 illustrates an embodiment in which the second type of storage comprises SLCs and the first type of storage comprises TLCs, and the SLC buffer is determined to be full at block 502. At block 504, the controller checks the data in the SLC buffer for tagging which indicates that the data had been previous identified as targeted/hot data, and intentionally migrated, written, or moved to the SLC buffer. At decision block 506, the controller determines whether the data has been tagged by the read reclaim algorithm. If so, the data should be excluded from the data reallocation or eviction to maintain the boosted performance of storing the data previous identified and tagged as hot data in the SLC buffer, as denoted by block 508. If the data has not been tagged by the read reclaim, the data may be evicted, reallocated, moved, or written from the SLC buffer to TLC storage at block 510.

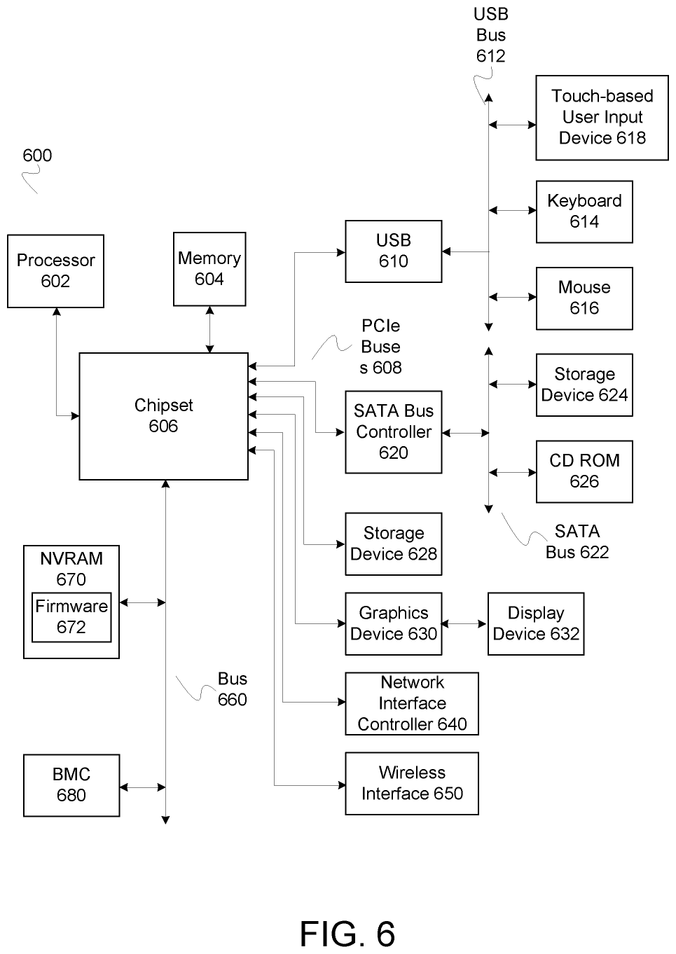

These example embodiments describe and illustrate various capabilities that enable data be more quickly retrieved from the hybrid storage device of an information handling system. The storage device and access techniques may be used in an information handling system, such as described with reference to FIG. 6, in which the storage 628 or storage 624 may be a hybrid storage device or accessed according to the techniques described above. In some embodiments, a data storage device according to embodiments of this disclosure may also be coupled through other interfaces to the information handling system, such as through network interface 640, wireless interface 650, or USB interface 610. The methods described above may execute on the CPU 602 when the CPU 602 executes non-transitory computer program code stored in the memory 604.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components. One example configuration of an information handling system is described with reference to FIG. 6.

FIG. 6 illustrates an example information handling system 600. Information handling system 600 may include a processor 602 (e.g., a central processing unit (CPU)), a memory (e.g., a dynamic random-access memory (DRAM)) 604, and a chipset 606. In some embodiments, one or more of the processor 602, the memory 604 and the chipset 606 may be included on a motherboard (also referred to as a mainboard), which is a printed circuit board (PCB) with embedded conductors organized as transmission lines between the processor 602, the memory 604, the chipset 606, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of the processor 602, the memory 604, the chipset 606, and/or other components may be organized as a System on Chip (SoC).

The processor 602 may execute program code by accessing instructions loaded into memory 604 from a storage device, executing the instructions to operate on data also loaded into memory 604 from a storage device, and generate output data that is stored back into memory 604 or sent to another component. The processor 602 may include processing cores capable of implementing any of a variety of instruction set architectures (ISAs), such as the x86, POWERPC®, ARM®, SPARC®, or MIPS® ISAs, or any other suitable ISA. In multi-processor systems, each of the processors 602 may commonly, but not necessarily, implement the same ISA. In some embodiments, multiple processors may each have different configurations such as when multiple processors are present in a big-little hybrid configuration with some high-performance processing cores and some high-efficiency processing cores. The chipset 606 may facilitate the transfer of data between the processor 602, the memory 604, storage 624 and other components. In some embodiments, chipset 606 may include two or more integrated circuits (ICs), such as a northbridge controller coupled to the processor 602, the memory 604, and a southbridge controller, with the southbridge controller coupled to the other components such as USB 610, SATA 620, and PCIe buses 608. The chipset 606 may couple to other components through one or more PCIe buses 608.

Some components may be coupled to one bus line of the PCIe buses 608, whereas some components may be coupled to more than one bus line of the PCIe buses 608. One example component is a universal serial bus (USB) controller 610, which interfaces the chipset 606 to a USB bus 612. A USB bus 612 may couple input/output components such as a keyboard 614 and a mouse 616, but also other components such as USB flash drives, or another information handling system. Another example component is a SATA bus controller 620, which couples the chipset 606 to a SATA bus 622. The SATA bus 622 may facilitate efficient transfer of data between the chipset 606 and components coupled to the chipset 606 and a storage device 624 (e.g., a hard disk drive (HDD) or hybrid solid-state disk drive (SDD) (624)) and/or a compact disc read-only memory (CD-ROM) 626. The PCIe bus 608 may also couple the chipset 606 directly to a storage device 628 (e.g., a solid-state disk drive (SDD)). A further example of an example component is a graphics device 630 (e.g., a graphics processing unit (GPU)) for generating output to a display device 632, a network interface controller (NIC) 640, and/or a wireless interface 650 (e.g., a wireless local area network (WLAN) or wireless wide area network (WWAN) device) such as a Wi-Fi® network interface, a Bluetooth® network interface, a GSM® network interface, a 3G network interface, a 4G LIE® network interface, and/or a 5G NR network interface (including sub-6 GHz and/or mmWave interfaces).

The chipset 606 may also be coupled to a serial peripheral interface (SPI) and/or Inter-Integrated Circuit (I2C) bus 660, which couples the chipset 606 to system management components. For example, a non-volatile random-access memory (NVRAM) 670 for storing firmware 672 may be coupled to the bus 660. As another example, a controller, such as a baseboard management controller (BMC) 680, may be coupled to the chipset 606 through the bus 660. BMC 680 may be referred to as a service processor or embedded controller (EC). Capabilities and functions provided by BMC 680 may vary considerably based on the type of information handling system. For example, the term baseboard management system may be used to describe an embedded processor included at a server, while an embedded controller may be found in a consumer-level device. As disclosed herein, BMC 680 represents a processing device different from processor 602, which provides various management functions for information handling system 600. For example, an embedded controller may be responsible for power management, cooling management, and the like. An embedded controller included at a data storage system may be referred to as a storage enclosure processor or a chassis processor.

System 600 may include additional processors that are configured to provide localized or specific control functions, such as a battery management controller. Bus 660 can include one or more busses, including a Serial Peripheral Interface (SPI) bus, an Inter-Integrated Circuit (I2C) bus, a system management bus (SMBUS), a power management bus (PMBUS), or the like. BMC 680 may be configured to provide out-of-band access to devices at information handling system 600. Out-of-band access in the context of the bus 660 may refer to operations performed prior to execution of firmware 672 by processor 602 to initialize operation of system 600.

Firmware 672 may include instructions executable by processor 102 to initialize and test the hardware components of system 600. For example, the instructions may cause the processor 602 to execute a power-on self-test (POST). The instructions may further cause the processor 602 to load a boot loader or an operating system (OS) from a mass storage device. Firmware 672 additionally may provide an abstraction layer for the hardware, such as a consistent way for application programs and operating systems to interact with the keyboard, display, and other input/output devices. When power is first applied to information handling system 600, the system may begin a sequence of initialization procedures, such as a boot procedure or a secure boot procedure. During the initialization sequence, also referred to as a boot sequence, components of system 600 may be configured and enabled for operation and device drivers may be installed. Device drivers may provide an interface through which other components of the system 600 can communicate with a corresponding device. The firmware 672 may include a basic input-output system (BIOS) and/or include a unified extensible firmware interface (UEFI). Firmware 672 may also include one or more firmware modules of the information handling system. Additionally, configuration settings for the firmware 672 and firmware of the information handling system 600 may be stored in the NVRAM 670. NVRAM 670 may, for example, be a non-volatile firmware memory of the information handling system 600 and may store a firmware memory map namespace of the information handling system. NVRAM 670 may further store one or more container-specific firmware memory map namespaces for one or more containers concurrently executed by the information handling system.

Information handling system 600 may include additional components and additional busses, not shown for clarity. For example, system 600 may include multiple processor cores (either within processor 602 or separately coupled to the chipset 606 or through the PCIe buses 608), audio devices (such as may be coupled to the chipset 606 through one of the PCIe busses 608), or the like. While a particular arrangement of bus technologies and interconnections is illustrated for the purpose of example, one of skill will appreciate that the techniques disclosed herein are applicable to other system architectures. System 600 may include multiple processors and/or redundant bus controllers. In some embodiments, one or more components may be integrated together in an integrated circuit (IC), which is circuitry built on a common substrate. For example, portions of chipset 606 can be integrated within processor 602. Additional components of information handling system 600 may include one or more storage devices that may store machine-executable code, one or more communications ports for communicating with external devices, and various input and output (I/O) devices, such as a keyboard, a mouse, and a video display.

In some embodiments, processor 602 may include multiple processors, such as multiple processing cores for parallel processing by the information handling system 600. For example, the information handling system 600 may include a server comprising multiple processors for parallel processing. In some embodiments, the information handling system 600 may support virtual machine (VM) operation, with multiple virtualized instances of one or more operating systems executed in parallel by the information handling system 600. For example, resources, such as processors or processing cores of the information handling system may be assigned to multiple containerized instances of one or more operating systems of the information handling system 600 executed in parallel. A container may, for example, be a virtual machine executed by the information handling system 600 for execution of an instance of an operating system by the information handling system 600. Thus, for example, multiple users may remotely connect to the information handling system 600, such as in a cloud computing configuration, to utilize resources of the information handling system 600, such as memory, processors, and other hardware, firmware, and software capabilities of the information handling system 600. Parallel execution of multiple containers by the information handling system 600 may allow the information handling system 600 to execute tasks for multiple users in parallel secure virtual environments.

The schematic flow chart diagrams of FIGS. 2, 4, and 5 are generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, although processors are described throughout the detailed description, aspects of the invention may be applied to the design of or implemented on different kinds of processors, such as graphics processing units (GPUs), central processing units (CPUs), and digital signal processors (DSPs). As another example, although processing of certain kinds of data may be described in example embodiments, other kinds or types of data may be processed through the methods and devices described above. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
identifying, by a controller of a non-volatile solid-state storage device, first data, stored in a first portion of the non-volatile solid-state storage device configured with a first type of cell, that matches a criteria based on access information regarding data stored in a solid state drive as targeted data; and
writing, by the controller of the non-volatile solid-state storage device, the targeted data to a second portion of the non-volatile solid-state storage device configured with a second type of cell.

2. The method of claim 1, wherein identifying the targeted data comprises reading read reclaim algorithm track read count for a plurality of NAND blocks, wherein the criteria is based on the read reclaim algorithm track read count.

3. The method of claim 2, wherein identifying the targeted data comprises determining blocks of the plurality of NAND blocks having a read reclaim algorithm track read count greater than a read reclaim trigger setting value.

4. The method of claim 1, further comprising tagging, by the controller of the non-volatile solid-state storage device, the targeted data with a tag based on the access information.

5. The method of claim 4, further comprising:
determining to evict data from the second portion of the non-volatile solid-state storage device;
identifying second data not associated with the tag; and
evicting the second data associated with the tag.

6. The method of claim 1, wherein the first portion comprises memory cells configured as higher-level cells (HLCs) and the second portion comprises memory cells configured as reduced-level cells (RLCs).

7. The method of claim 1, wherein the writing is performed during a read reclaim operation.

8. An apparatus, comprising:
a memory;
a processor coupled to the memory, wherein the processor is configured to perform steps comprising:
identifying, by a controller of a non-volatile solid-state storage device of a non-volatile solid-state storage device, first data, stored in a first portion of the non-volatile solid-state storage device configured as a first type, that matches a criteria based on access information regarding data stored in a solid state drive as targeted data; and
writing, by the controller of the non-volatile solid-state storage device, the targeted data to a second portion of the non-volatile solid-state storage device configured with a second type of cell.

9. The apparatus of claim 8, wherein identifying the targeted data comprises reading read reclaim algorithm track read count for a plurality of NAND blocks in the SSD.

10. The apparatus of claim 9, wherein identifying the targeted data comprises determining blocks of the plurality of NAND blocks having a read reclaim algorithm track read count greater than a read reclaim trigger setting value.

11. The apparatus of claim 8, further comprising tagging, by the controller of the non-volatile solid-state storage device, the targeted data with a tag based on the access information.

12. The apparatus of claim 11, further comprising:
determining to evict data from the second portion of the non-volatile solid-state storage device;
identifying second data not associated with the tag; and
evicting the second data associated with the tag.

13. The apparatus of claim 8, wherein the first portion comprises memory cells configured as higher-level cells (HLCs) and the second portion comprises memory cells configured as reduced-level cells (RLCs).

14. The apparatus of claim 8, wherein the apparatus is a solid state drive (SSD), and wherein the processor is a SSD controller.

15. An information handling system, comprising:
a solid state drive (SSD) comprising:
a plurality of NAND blocks;
a controller coupled to the plurality of NAND blocks, wherein the controller is configured to perform steps comprising:
identifying, by a controller of a non-volatile solid-state storage device of a non-volatile solid-state storage device, first data, stored in a first portion of the non-volatile solid-state storage device configured with a first type of cell, that matches a criteria based on access information regarding data stored in a solid state drive as targeted data; and
writing, by the controller of the non-volatile solid-state storage device, the targeted data to a second portion of the non-volatile solid-state storage device configured with a second type of cell.
a memory;
a processor coupled to the SSD and to the memory, wherein the processor is configured to perform steps comprising:
executing an application comprising random read operations to the SSD for retrieving application data from the plurality of NAND blocks,
wherein the first data corresponds to the application data.

16. The information handling system of claim 15, wherein the SSD is configured to respond to the random read operations by retrieving the application data from the second portion of the non-volatile solid-state storage device.

17. The information handling system of claim 15, wherein identifying the targeted data comprises reading read reclaim algorithm track read counts for a plurality of NAND blocks in the SSD.

18. The information handling system of claim 16, wherein identifying the targeted data comprises determining blocks of the plurality of NAND blocks having a read reclaim algorithm track read count greater than a read reclaim trigger setting value.

19. The information handling system of claim 15, further comprising tagging, by the controller of the non-volatile solid-state storage device, the targeted data with a tag based on the access information.

20. The information handling system of claim 19, further comprising:
determining to evict data from the second portion of the non-volatile solid-state storage device;
identifying second data not associated with the tag; and
evicting the second data associated with the tag.
